(19) United States
(12) Patent Application Publication
(10) Pub. No.: US 2018/0323996 A1
(43) Pub. Date: Nov. 8, 2018

(54) AUTOMATIC GENERATION OF SCENES USING AN ASSISTANT DEVICE

(71) Applicant: Essential Products, Inc., Palo Alto, CA (US)

(72) Inventors: Manuel Roman, Sunnyvale, CA (US); Morten Torkildsen, Sunnyvale, CA (US); Shobhit Gupta, Milpitas, CA (US)

(21) Appl. No.: 15/950,898

(22) Filed: Apr. 11, 2018

Related U.S. Application Data
(60) Provisional application No. 62/503,251, filed on May 8, 2017.
(60) Provisional application No. 62/644,866, filed on Mar. 19, 2018.

(51) Int. Cl. H04L 12/28; H04L 29/08; G06F 15/18

(52) U.S. Cl. CPC H04L 12/2829; H04L 12/282; G06F 15/18; H04L 12/2818; H04L 67/22

(57) ABSTRACT

Presented here are methods by which an assistant device can learn user's habits in controlling the appliances associated with the assistant device. The assistant device can automatically learn which appliances-controlling actions tend to be performed together, and group those actions into scenes. Further, the assistant device can recognize the condition frequently present before a scene or an action within the scene is performed, and create a trigger for the scene and/or the action. The assistant device can automatically recognize the condition is present in the future, and offer to perform the scene and/or the action.

### CROSS-REFERENCE TO RELATED APPLICATIONS

This application claims priority to U.S. Provisional Patent Application No. 62/503,251, filed on May 8, 2017, and to U.S. Provisional Application No. 62/644,866, filed Mar. 19, 2018, both of which are incorporated herein by this reference in their entirety.

### TECHNICAL FIELD

The present application is related to assistant devices, and more specifically to methods and systems that automate generation of scenes using assistant devices.

### BACKGROUND

The Internet of Things (IoT) allows for the internetworking of devices to exchange data among themselves to enable sophisticated functionality. For example, assistant devices configured for home automation can exchange data with other appliances to allow for the control and automation of lighting, air conditioning systems, security, etc. Existing solutions require users to select individual appliances, and ascribe settings to them one-by-one, potentially within a menu format.

### SUMMARY

Presented here are methods by which an assistant device can learn user's habits in controlling the appliances associated with the assistant device. The assistant device can automatically learn which appliances-controlling actions tend to be performed together, and group those actions into scenes. Further, the assistant device can recognize the condition frequently present before a scene or an action within the scene is performed, and create a trigger for the scene and/or the action. The assistant device can automatically recognize the condition is present in the future, and offer to perform the scene and/or the action.

### BRIEF DESCRIPTION OF THE DRAWINGS

These and other objects, features and characteristics of the present embodiments will become more apparent to those skilled in the art from a study of the following detailed description in conjunction with the appended claims and drawings, all of which form a part of this specification. While the accompanying drawings include illustrations of various embodiments, the drawings are not intended to limit the claimed subject matter.

FIG. 1 illustrates an embodiment of the assistant device monitoring a user's appliance use.

FIG. 2 illustrates the process of analyzing use information and identifying scenes.

FIG. 3 illustrates an embodiment of matching a scene template to an activity pattern.

FIG. 4 illustrates scene templates stored locally and remotely.

FIG. 5 illustrates an example scene curated by the assistant device.

FIG. 6 shows the sequence of actions and scenes constructed from the sequence of actions.

FIG. 7 shows the assistant device utilizing anonymized pattern of use data from other assistant devices.

FIG. 8 shows various triggers for a scene and/or triggers for an action within the scene.

FIG. 9 shows a system to initialize a new assistant device.

FIG. 10 shows a relationship between a generic identification (ID) of an appliance, and a generic appliance instruction and a specific ID of an appliance and the specific appliance instruction.

FIG. 11 is a flowchart of a method to automatically learn user's habitual actions of controlling home appliances and automatically offer to perform the user's habitual actions of controlling home appliances.

FIG. 12 is a flowchart of a method to determine a scene and/or action trigger.

FIG. 13 is a diagrammatic representation of a machine in the example form of a computer system within which a set of instructions, for causing the machine to perform any one or more of the methodologies or modules discussed herein, may be executed.

### DETAILED DESCRIPTION

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two appliances may be coupled directly, or via one or more intermediary channels or appliances. As another example, appliances may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application”) may include one or more modules, or a module may include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### Overview

The systems and methods disclosed here enable an assistant device, such as a home assistant, to learn common actions performed by the user in controlling the appliances associated with the assistant device, and group the common actions into scenes, which can later be performed again. The assistant device does not require a user to explicitly program the assistant device, or explicitly alert to the assistant device that the assistant device should start learning. Instead, the assistant device enables a lay user without a programming background or a special actual knowledge of the assistant device to interact with the assistant device, while the assistant device is learning the user's habits.

### Generating Machine-Curated Scenes

A home can include many different appliances capable of providing different functionalities for a user. For example, a person waking up in the morning might open her blinds, prepare some coffee with a coffee machine, turn on the television and switch to a news channel, and read a current traffic report on her tablet providing details on her commute to work that morning. This means that the user has a routine in which the same functionalities of the appliances in the environment of her home are expected to be performed on the same day at the same time. Other times, the user might engage in some activity many times, but not at a routine schedule. For example, the user might have a movie night on a Thursday at 7:30 PM and then another movie night on a Saturday at 11:00 PM. However, movie night on the different days might involve similar functionalities to be performed by the appliances in the home, such as dimming the lights in the living room, turning on the television and opening a streaming video application to play back a movie, and turning on the sound system to play back audio at a certain volume. The user can use these appliances manually or request an assistant device within the home to control the corresponding appliances to perform the functionalities.

As disclosed herein, the assistant device can identify the functionality performed by the appliances as requested or performed by the user (i.e., monitor the use of the appliances within the home) and collect information regarding what is happening within the environment of the assistant device, for example, what the user is speaking, what activities other than functionality of the appliances are occurring, other people within the environment, etc. All of this information can be filtered such that the relevant information related to the functionality of the appliances can be provided as an activity pattern. For example, the related functionality (e.g., the user's morning routine) can be determined as the relevant information. The activity pattern can then be compared with a library of scene templates each representing corresponding functionalities of appliances as well as appliance types, times the functionalities were performed, the users within the environment, etc. for different events (e.g., morning, movie night, etc.). Based on similarities between the activity patterns and the scene templates, the assistant device can generate a scene that indicates how and when the functionalities of the appliances should be performed. Additionally, the scene can be associated with a “trigger” such as a phrase (e.g., “movie night”) so that the user can recite the phrase for the assistant device to then control the various appliances to perform the functionalities. When a new appliance is detected within the home, the assistant device can also determine its functionalities, characteristics, location, etc. and the assistant device can modify the scene to incorporate using the new appliance. As a result, new appliances and their functionalities can be easily included within the user's routine as provided via the automated appliances.

An assistant device can perform a set of actions associated with scenes. Scenes can include events which occur though the day (e.g., bedtime, morning, movie night, etc.). Thus, users can use the disclosed features to customize their homes to create an automated home environment. The home environment can include any physical environment within the range of the assistant device, a short range wireless network, and/or a wireless network provided by or used by the assistant device. The connected appliances can be connected to the assistant device using a short range wireless network, and/or a wireless network. In at least one embodiment, the appliances are connected to the assistant device using a local network which can include one or more of LTE, LTE-Advanced, Wi-Fi, Bluetooth, ZigBee, EnOcean, Personal area networks, TransferJet, Ultra-wideband, WiMAX, HiperMAN, Li-Fi, and/or IR.

An assistant device can be set up in a home environment to provide speech-based responses to a user's speech. In some embodiments, the appliances connected to the assistant device can be associated with one or more of voice activatable commands, appliance categories, descriptive information, and activity types. The information associated with one or more connected appliances such as voice activatable commands, appliance categories, appliance descriptions, and activity types can be stored in a database accessible to the assistant device. Furthermore, one or more adapters can be stored, which allows the assistant device to operate the one or more appliances. In an embodiment, the users of the assistant device can control the connected appliances via one or more of speech, physical gesture (e.g., mouthing “turn off”, moving hand in a specific pattern, looking at the assistant device with a specific expression, by providing some physical action, etc.), and/or textual input.

In at least one embodiment, the assistant device has access to a database which stores a list of connected appliances and one or more of the associated adapters, the activity types, appliance descriptions, and/or appliance categories. In an embodiment, during the setup of the connection between the assistant device and the one or more appliances, one or more of the associated adapters, the activity types, appliance descriptions, and/or appliance categories are identified and stored in the database. This information can then be accessible to the assistant device and used for controlling the appliances via the assistant.

For example, a smart thermostat connected to the assistant device can be controlled by user instruction. Once the user provides the user instructions “assistant device, please set the temperature to 72 degrees on the thermostat,” the assistant device can identify voice activatable commands for the appliance such as voice activatable commands to control functions of the thermostat that set temperature, increase heat, or decrease heat. The user operation of the appliance can include oral speech, such as the user instruction “set the temperature to 72 degrees,” which causes the assistant device to set the thermostat to 72 degrees.

The appliance description identified within the user instructions can indicate which appliance the user intends to control. The appliance description can include identifying information about the appliance. The assistant device can store appliance descriptions about the appliances such as the appliance location, type, and/or color (e.g., kitchen, toaster, silver, etc.). In an example, the user provides an instruction “turn on the Cuisinart coffee maker please.” The assistant device determines that “Cuisinart” is the appliance description of one of the two previously identified adapters that match “coffee maker” and “turn on”, then narrows down the adapters to one unique adapter. In an embodiment, the assistant device can use one or more of the adapters associated with appliances, the activity types, appliance descriptions, and/or appliance categories to generate machine curated scenes.

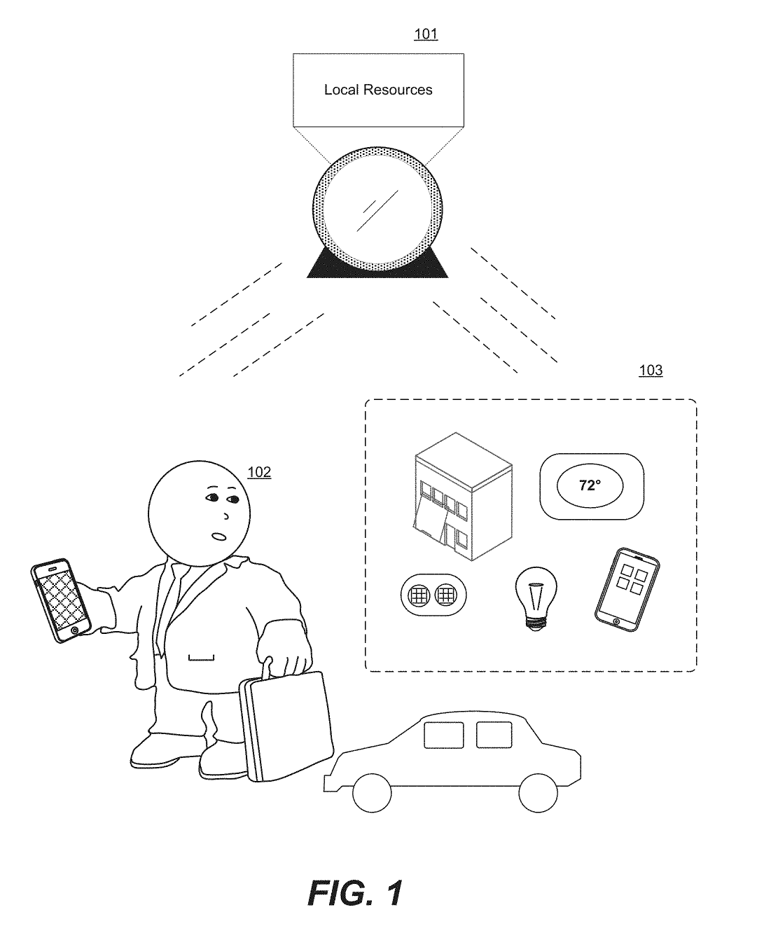

FIG. 1 illustrates an embodiment of the assistant device monitoring user's appliance use. In a home environment, a user 102 may interact with many appliances 103. In an embodiment, the assistant device 101 can collect the interaction information. For example, the assistant device can collect that a user turned on the bedroom lights at 7 a.m. and made coffee at 7:15 a.m. The assistant device 101 can collect the use information including identifying information about the user performing the use (e.g., user A, user B, etc.), the appliance used (e.g., microwave, thermostat, speaker, etc.), the functionality of the appliance initiated during the use (e.g., turn on, turn off, raise volume, etc.), the time, the date, and the duration of use (e.g., 2 minutes, 15 seconds, etc.). The use information can include instructions to the home appliance to control an appliance (e.g., “turn on the Cuisinart coffee maker please”), a user's manual use of appliances (e.g., user turning on the coffee maker him/herself) and/or occurrences within the environment (e.g., alarm clock ringing).

The use information collected can include metadata, appliance communication data, audio and video data, voice activatable commands, appliance categories, and/or appliance descriptions. Collected audio and video data can include data collected by the microphone and/or camera of the assistant device. The audio and video data can also include data collected by appliances connected to the assistant device such as an external camera. In an embodiment, the video data is the result of a visual recognition analysis of video input. The visual recognition can be based on analyzing image frames.

The audio data can include a result of an audio recognition analysis of audio data. The audio recognition algorithm can include speech recognition algorithms including one or more of Hidden Markov models, dynamic time warping-based speech recognition, neural networks, deep feedforward neural networks, end-to-end ASRs, and/or other similar algorithms.

In some embodiments, not all collected data is stored as use information. In at least one embodiment, only relevant use information is stored as use information. The relevancy of information can be determined by the temporal proximity of data to a use of an appliance. For example, video and audio data may be determined to be irrelevant if no use of an appliance occurred within a specific amount of time. In other words, the audio and video data of a user walking around the living room 20 minutes before turning on the coffee maker can be determined to be irrelevant. In at least one embodiment, specific information such as audio data generated by specific sources can be determined to be irrelevant. For example, audio data generated by a television or radio may be determined to never be relevant, and therefore is not stored with use information. In some embodiments, the relevancy of information determined by spatial proximity can be a factor in determining whether the information is relevant. For example, the audio and video data collected from the living room can be determined to be irrelevant to the use of the coffee maker in the kitchen. In some embodiments, only data by specific users is considered relevant. For example, data about the movement of a child can be determined to be irrelevant. Furthermore, movements such as the movement of a pet can be determined to be irrelevant data and therefore not stored as use information.

In some embodiments, the assistant device collects all available data and then stores only the information within a specific temporal threshold of the appliance use (e.g., lights turned on, TV turned off, locked deadbolt, etc.). For example, the assistant device collects all information and then deletes it unless the information is collected from one minute before until one minute after an appliance use occurs. In some examples, this data is further analyzed to determine relevancy, and only relevant information is stored as use information.

In some embodiments, the video and audio data is further analyzed to generate a transcript. The transcript can include a combination of audio and visual input. The transcript can be stored as use information. In at least one embodiment, only relevant portions of the transcript are stored as use information. The audio and video input can also be analyzed to determine the user. In an example, a user A, while pointing to an IoT appliance, can make a statement to the assistant device “turn this on.” The assistant device can then identify the text of the user response to include the keywords “turn on” and “this.” The keyword “this” can trigger the assistant device to examine video input to determine to which appliance the command is being directed. The video input can be examined using a visual recognition algorithm. The result of the visual recognition algorithm can be used to determine that a user is pointing to a SmartTV.

One or more visual recognition algorithms and/or speaker recognition algorithms can further determine that user A is the user talking. In at least one embodiment, the assistant device stores user profiles including characteristics which the appliance can use to identify the user. Characteristics can include biometric information including voice biometrics. Based on both the visual and audio input, the assistant device can then determine that the user's response includes a request to turn on the SmartTV. In the example, the assistant device can store the following entry as use information: “SmartTV, on, 4/12/2017, 10 a.m., user A, audio command.”

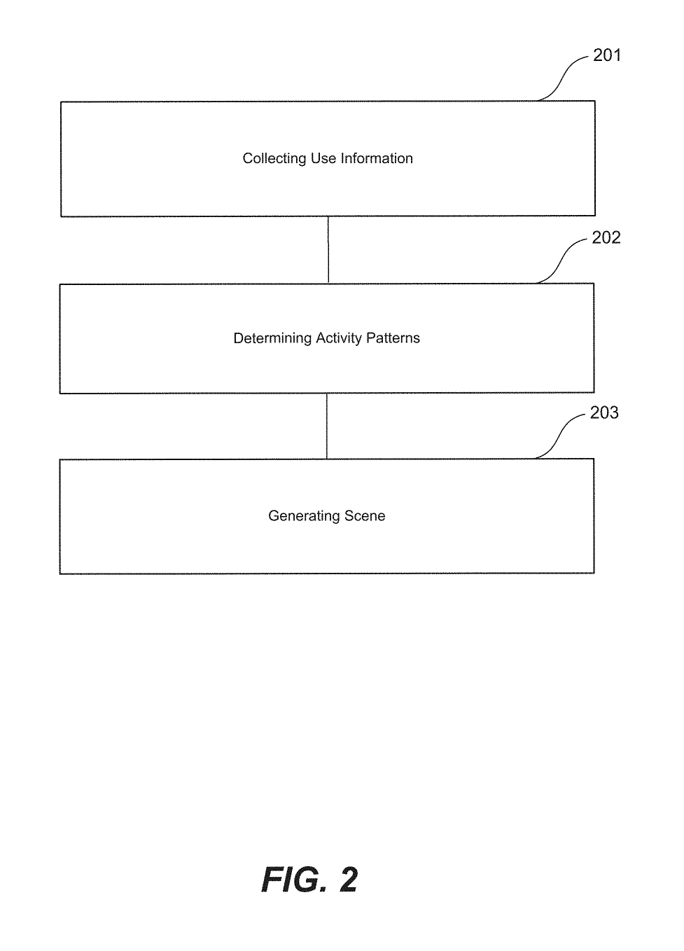

FIG. 2 demonstrates the process of analyzing use information 201 and identifying scenes 203. Activity patterns can be determined 202 by analyzing the activities in the use information 201. Use information 201 can include user interaction with appliances in the home environment. For example, use information 201 can include a user turning off the lights manually, turning off the lights via an appliance such as a smart phone and/or requesting the assistant device to turn off the lights. Other examples of use information 201 can include a user opening the garage door, arming the security system, closing curtains, turning off an alarm clock, making coffee, adjusting the temperature on the thermostat, etc.

The use information 201 can be analyzed by one or more machine learning algorithms. The machine learning algorithms can include one or more of decision tree learning, association rule learning, artificial neural networks, deep learning, inductive logic programming, support vector machines, clustering, Bayesian networks, reinforcement learning, representation learning, similarity and metric learning, sparse dictionary learning, genetic algorithms, rule-based machine learning, learning classifier systems, supervised learning, unsupervised learning, semi-supervised learning, clustering algorithms, and/or classification algorithms. In at least one embodiment, external information is used to determine activity patterns. External information can include calendar information, weather, news, and social media.

In at least one embodiment, the use information 201 can be used to identify activity patterns. For example, the assistant device can determine that the daily events or activities of a user such as opening the IoT curtains, turning on the bathroom light, using the electronic toothbrush, and turning on the coffee machine within a 20-minute window are related activities. Using calendar information, the assistant device can further determine that the related activity pattern only occurs on weekday mornings. The activity pattern can be determined using a fuzzy matching algorithm. An activity pattern can be determined when the match is less than perfect. In at least one embodiment, a match threshold can be set.

In another example, the assistant device can determine that the television being turned on in the evening, dimming the lights and making popcorn are related activities. In the example, the related activities do not occur on a scheduled interval and therefore can be determined to be related activities based on a match threshold.

In at least one embodiment, the activity pattern 202 is determined using data from multiple users. In some embodiments, the activity pattern 202 is determined specific to individual users. In at least one embodiment, activity initiated by multiple users and determined to be related can be used to determine an activity pattern 202. In at least one embodiment, the activity is determined to be related when the users interact with each other in temporal proximity to their respective actions. For example, if two users are talking and then a minute later one user performs the action of turning off the lights and the other user performs the activity of making popcorn, then these two actions can be determined to be related and identified as an activity pattern 202.

In at least one embodiment, entries from one or more calendars are used to determine details about related activities and can be used to identify the scene. For example, when the assistant device determines that the TV is turned on in the evening, the lights are turned off, and popcorn is made are related activities, the user's calendar can be reviewed for calendar entries and can be matched. In the example, the assistant device can identify that the user has a calendar entry marked “watched football game” in a temporal proximity to the related activity. In at least one embodiment, the matching of calendar entries to related activities can include identifying participants in the calendar entry and comparing them to the participants in the related activity set.

Once the related activity is identified, it can be used to create a scene. A scene can include one or more actions and/or a set of actions. The actions can include the functionalities and behaviors of appliances and the assistant device. For example, a set of actions in a “bedtime” scene can include turning off the lights, arming the security system, and locking the deadbolt. Scenes can be initiated by a trigger or combination of triggers including a user instruction, a user gesture, selecting the scene on the screen of the assistant device or connected appliance (e.g., phone), a set of actions, a scheduled time, or an event (e.g., alarm clock ringing, visitor at the door, etc.). If the “bedtime” scene is configured, the user can state “assistant device, it's bedtime.” In response to the user instruction, the assistant device can initiate the set of actions associated with the “bedtime” scene which can include turning off the lights, arming the security system, and locking the deadbolt. In another example, the user can instruct the assistant device via a physical gesture such as signing “bedtime” using American Sign Language and/or mouthing the word. This physical gesture can be set as a scene trigger and cause the assistant device to initiate the set of actions associated with “bedtime.” The trigger for the “bedtime” scene can also be a set of actions such as all users in the home environment going to sleep.

In an embodiment, the assistant device monitors activity, and when an activity pattern occurs a threshold number of times (e.g., 5 times per week, twice per day, 2 times per month, etc.), the assistant device either prompts the user to set up the scene and/or automatically generates the scene. The threshold can be preconfigured. In at least one embodiment, the threshold can be adjusted based on the user. Users can have associated user profiles; the user profiles can include a patience metric. The patience metric can measure the user's capacity to tolerate system errors and/or delays. For example, a user who frequently uses an angry tone, angry words, and frustrated gestures can have a low patience metric, and therefore the activity pattern match threshold can be set to higher than the system default. In at least one embodiment, each user is associated with a default patience threshold, which is adjusted based on that user's behavior over time.

In at least one embodiment the user can create a scene by providing instructions to the assistant device. The user may want to set up the scene without waiting for the assistant device to determine an activity pattern in which case the user can instruct the assistant device to create a scene by selecting appliances, actions to be performed (e.g., functionalities such as turn on, turn off), and the trigger (e.g., word or set of words to activate the scene, a gesture, etc.). The user can create the scene using the display of the assistant device to provide the instructions, via verbal input, via connected appliance (e.g., phone), and/or physical gesture (e.g., pointing at an appliance, sign language, etc.). For example, the user can provide instructions “assistant device, I would like to setup a morning scene, can you help me?” In response the assistant device can reply “yes, I am happy to help you set up the morning scene. What activities should be associated with this scene?” The user can respond “The morning scene should include making coffee, opening the curtains in my bedroom and providing me with the traffic report.” In response, the assistant device can ask for clarification on some of the activities or create the scene.

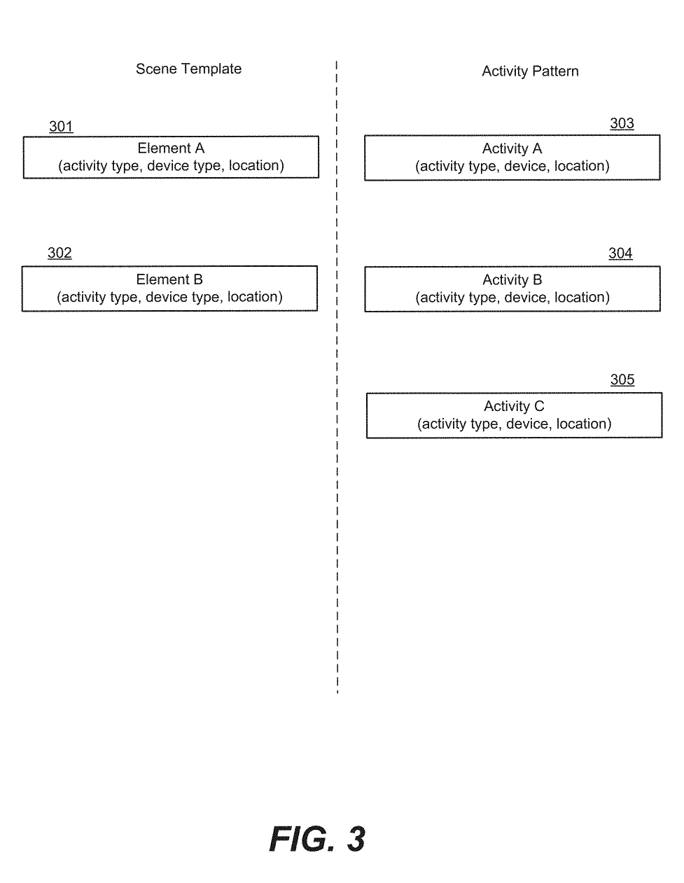

FIG. 3 illustrates matching a scene template to an activity pattern. A scene template can include a plurality of elements such as element A 301 and element B 302. Each element can include one or more of activity types and/or appliance categories. In the “bedtime” scene example, the “bedtime” scene template can include an element with an activity type of control lights and the appliance category “lights” and another element with an activity type “security” and the appliance category “security system.” Other scene templates can exist including “wakeup routine,” “movie night,” “kids are sleeping,” and “work from home” templates.

Each template can have predefined elements associated with the unique scene. Each template can include unique elements typical to the unique scene. In an example, the “kids are sleeping” scene template can include activity types “communication” and “illumination” and appliance categories “phone” and “lights.” In at least one embodiment, the elements can include a location, time of day (e.g., morning, 12-2 pm, lunch time, etc.), and/or demographic information. For example, the “move night” scene template can include an element which has an activity type “illumination,” appliance category “lights,” time “evening,” and location “living room.”

The demographic information can be information about a user's likeliness to have activity patterns that match. For example, the use demographic information of a “playtime” scene template could be set to child user. The demographic information can include any unique information about a particular group such as adult, woman, man, child, young adult, parent, student, doctor, lawyer, etc.

The assistant device can have popular scene templates stored in the local resources. The scene templates can be matched to the activity pattern 202 to generate a customized scene for the home environment. The activity pattern 202 can be analyzed to determine the activity, activity type, the appliance, the appliance category, time, calendar day, and/or location of each activity. The activity pattern can be matched against scene templates. The matching can be accomplished using one or more data matching algorithms. The matching algorithms can include calculating a match score. In at least one embodiment, fuzzy matching is used to determine a match.

In at least one embodiment, a match is less than 100% perfect. The imperfect match can include a present threshold which is preset for all scene templates. In at least one embodiment, each scene template is associated with a threshold for a match. The number of elements associated with a scene template can be correlated to the threshold amount. For example, a scene template with seven elements can be associated with a lower match threshold than a scene template with two elements. In another example, a scene template with seven elements can be associated with a higher match threshold requirement than a scene template with two elements. In at least one embodiment, the matching includes the weighted relevance of each potential matching factor. For example, the demographic information can have a very low weight. Thus, a man performing a set of actions identified in the scene template as young adult demographic activity would still yield a match.

In at least one embodiment, the match threshold can be adjusted based on the user. Users can have associated user profiles; the user profiles can include a patience metric. The patience metric can measure the user's capacity to tolerate system errors and/or delays. For example, a user who frequently uses an angry tone, angry words, and frustrated gestures can have a low patience metric and therefore the scene template match threshold can be set to higher than the system default. In at least one embodiment, each user is associated with a default patience threshold, which is adjusted based on that user's behavior over time.

Once an activity pattern is determined to match a scene template, the assistant device can create a customized scene for the user. In an embodiment, once an activity pattern and scene template are found to match, the customized scene is created automatically, and the assistant device can notify the user that the customized scene has been created. For example, when the assistant device identifies that the user engaged in an activity pattern (e.g., open curtains, make coffee, and turn on news) which matches the “good morning” scene template, the assistant device can tell the user “I noticed you have a morning activity pattern; I've created a scene which allows for the activities to be performed automatically. You just need to say ‘initiate good morning scene.’ I can also set up a different scene trigger if you'd like.”

In at least one embodiment, the assistant device can prompt the user to set up the customized scene. After detecting an activity pattern and determining a matching scene template, the assistant device can prompt the user “I noticed you have a repeating morning activity pattern; would you like me to set it up so that you can perform all the actions with one trigger?” In the example, if a user responds “yes,” the assistant device can automatically set up the customized theme, and the assistant device can further allow users to add activities and add a trigger to the customized scene. For example, the assistant device can add an activity of starting the car and opening to the garage door to the weekday morning routine. The assistant device can further allow the user to customize the trigger, including having the trigger set to an event (e.g., an alarm clock ringing, etc.).

In at least one embodiment, when an appliance is newly connected, the assistant device may provide an option to add the appliance to an existing scene. The appliance type, activity type, and/or location of the newly connected appliance can be determined to match the elements of the scene template associated with a scene. Once the match is determined, the assistant device can provide an option for the user to add the newly connected appliance to an existing scene. For example, if a new curtain appliance is installed in the bedroom, the assistant device can determine that the new curtain appliance is an element of a scene template associated with the “morning” scene and prompt the user to add the curtain appliance to the scene.

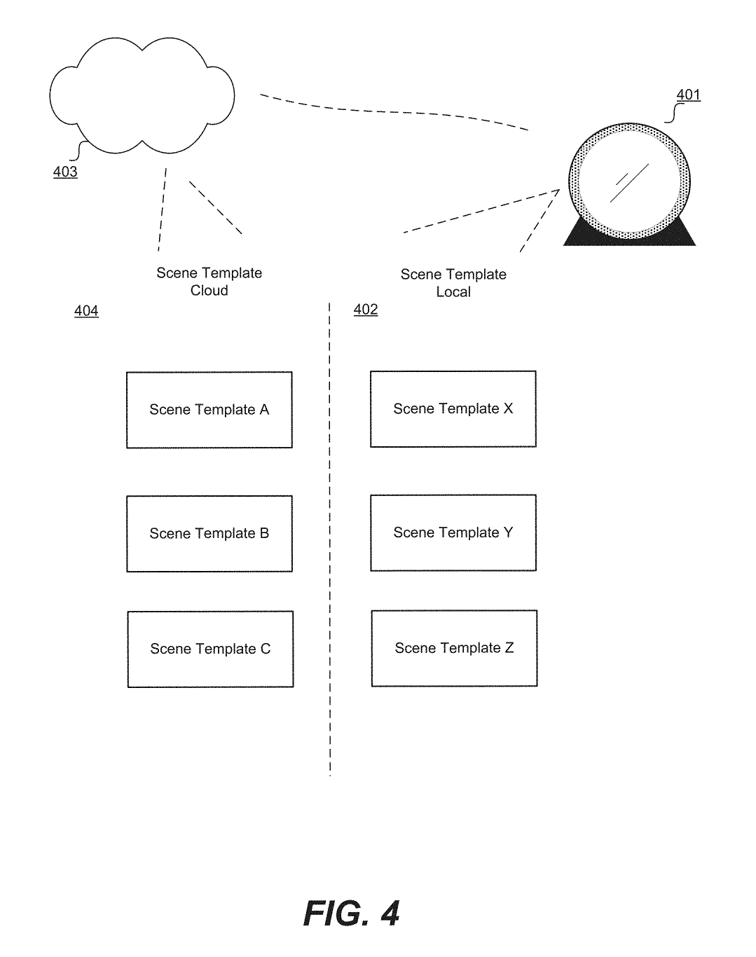

FIG. 4 illustrates scene templates stored locally 402 and remotely 404. In some embodiments, the local storage resources are limited, and therefore to increase storage efficiently only a limited number of scene templates are stored locally 402. In at least one embodiment, all scene templates are stored on the cloud, and none are stored locally 402. Local resources of an assistant device 401 can include assistant device local memory storage, storage directly connected to the assistant device, and/or storage of connected appliances. In at least one embodiment, local resources do not include storage directly connected to the assistant device and/or storage of connected appliances. In at least one embodiment, the remote server is a cloud server 403.

In one embodiment, the assistant device includes common scene templates. For example, common scene templates can include “morning routine” and “bedtime.” These scene templates can be preloaded on the appliance. In an embodiment, the assistant device can study or analyze the home environment to determine which scene templates are likely to be the most relevant in the environment. For example, the assistant device can determine that there are children in the home and therefore identify that the scene templates associated with households having children should be loaded and/or prefetched.

The assistant device can study the home environment by performing visual recognition and/or speech recognition of the surrounding environment. That is, assistant device 401 can determine information about users by analyzing captured video of the individuals in the home environment and/or by analyzing text upon objects within its surrounding environment and then use that text to determine the information about the users in the home. In an example, the assistant device can detect information, such as age, gender, height, etc., about users in the home environment. The assistant device can also detect a children's book and determine that children live in the home. Based on the visual recognition of the text in the surrounding environment, the assistant device can determine information about the users in the home such as age and gender. The visual recognition can be based on analyzing image frames by, for example, using a camera of the assistant device. A biometric algorithm can be used to identify the age and/or gender of the individuals in the home. The visual recognition algorithm can also be used to determine information about the users of the physical environment in which assistant device is placed, and those image frames can be analyzed for content (e.g., age, gender, and text upon objects depicted in the image frames) to determine information about the users in the environment. In at least one embodiment, the analysis or study of the home environment includes excluding outliers (e.g., visitor to the home, one book, etc.). In at least one embodiment, a machine learning algorithm is used to determine the information about users in the home.

In an embodiment, the assistant device can use the result of studying the home environment to determine which scene templates are likely to be the most relevant in the environment and load them from the cloud resources to the local resources. In at least one embodiment, the assistant device uses one or more results of the study of the home and/or the geolocation of the assistant device. The assistant device can determine the geolocation by Wi-Fi triangulation, GLONASS, GPS, and/or geographic location associated with the Internet Protocol (IP) address, MAC address, RFID, hardware embedded article/production number, embedded software number (such as UUID, Exif/IPTC/XMP or modern steganography), Wi-Fi positioning systems, or a combination of two or more of these.

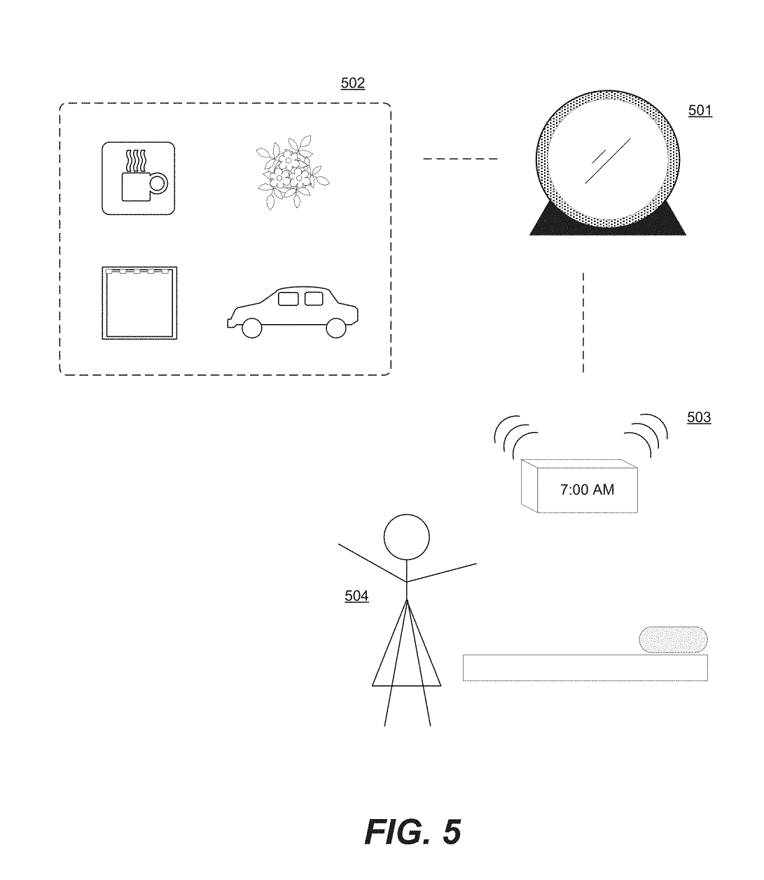

FIG. 5 illustrates an example scene curated by the assistant device 501. Upon detecting the alarm clock sound 503, the assistant device 501 can determine that the alarm clock sound 503 is the trigger for the “morning” scene. The “morning” scene can include the assistant device 501 transmitting instructions to the relevant appliances 502 in the environment to perform activities such as watering plants, making coffee, and opening the curtains. The scene can further include activities performed by the assistant device 501 such as providing a traffic report to the user 504.

The scene can further include specific times to perform certain activities. For example, the traffic report can be timed to be provided to the user 504 only after the user 504 drinks his/her coffee. In another example, the traffic report can be provided to the user 504 at a specific time after the alarm clock sounds (e.g., 20 minutes after alarm clock sounds, etc.).

In at least one embodiment, scenes can be preconfigured and initiated by an external source such as a news source. For example, scenes such as silver alert, amber alert, earthquake warnings, tornado warnings, and/or other natural disaster warnings can be initiated by an external source. External sources can include Integrated Public Alert & Warning Systems, Emergency Alert Systems, news sources, etc. In at least one embodiment, the trigger is the assistant detecting an Emergency Alert sent to TV and/or radio broadcasters.

### Scene Grouping and Scene Triggering

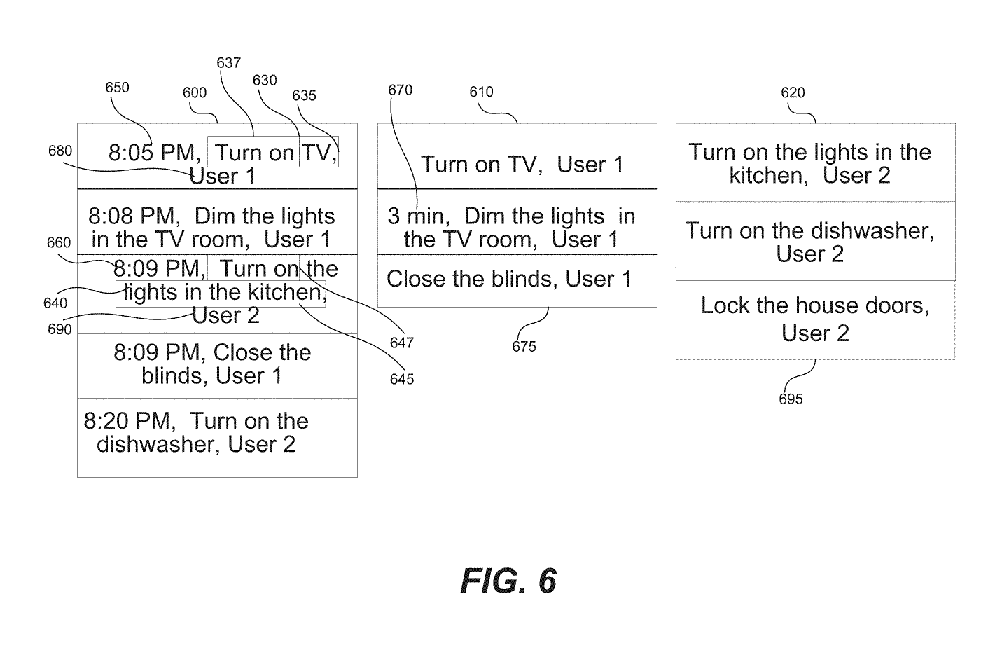

FIG. 6 shows the sequence of actions 600 and scenes 610, 620 constructed from the sequence of actions. The sequence of actions 600 can contain a time 650, 660 (only two labeled for brevity) in which an action 630, 640 (only two labeled for brevity) has been performed by a user 680, 690 (only two labeled for brevity). The actions 630, 640 can be performed by one or more users. The actions 630, 640 can include an appliance 635, 645 and an instruction 637, 647 to the appliance. The appliances 635, 645 have a function such as making coffee, washing the dishes, watering the lawn, regulating temperature, etc.

The scenes 610, 620 are constructed from the sequence of actions 600. To construct the scenes the assistant device can group the actions into one or more groups. When constructing the scenes 610, 620, the assistant device can remove the timing information 650, or optionally, can keep a timing difference 670 between the sequence of actions in a scene. The timing difference 670 can be defined in reference to the first action of the scene 610, or a prior action in the scene, and can be expressed in precise terms, such as 3 minutes shown in FIG. 6. The timing difference 670 can be expressed approximately, such as with the term “subsequently”, “simultaneously”, or “prior to” the reference action of the scene 610. Further, when there is no timing difference 670, as shown in action 675, the assistant device can determine a time to perform the action 675. For example, the assistant device can learn from prior history of user timings, as described in this application.

The assistant device can group the sequence of actions 600 into separate scene 610, 620 based on the user executing the action (as shown in FIG. 6), based on time, semantic differences, appliances being controlled, prior groupings and clustering of actions, etc. For example, scene 610, 620 can be grouped by the user, i.e. the person issuing the command. In another example, if a certain amount of time passes, such as two hours, between two subsequent actions, even if they're issued by the same user, the two subsequent actions can be grouped into separate scenes. In a third example, if a user has historically performed a certain scene 90% of the time, and presently, the user introduces a variation into the scene, the assistant device can ignore the variation, and not group the variation with the scene. In a fourth example, the assistant device can determine a cluster of actions such as the user tends to control the lights, the TV, and the locks together. If presently, the user controls the lights, the TV, the locks, and a coffee maker, the assistant device can exclude the action controlling the coffee maker from the scene. The clustering of actions can be based on a single user, or can be based on a group of users, such as various users of various home appliances in various homes.

The assistant device can create the scene 610, 620 based on learning from the user and/or other users of the assistant device similar to the user. For example, the assistant device can create to the scene 620 at time T1. At time T2, the assistant device can notice that at time T2, 70% of the time the user has executed scene 620 as well as an action 695. Consequently, the assistant device can add the action 695 to the scene 620.

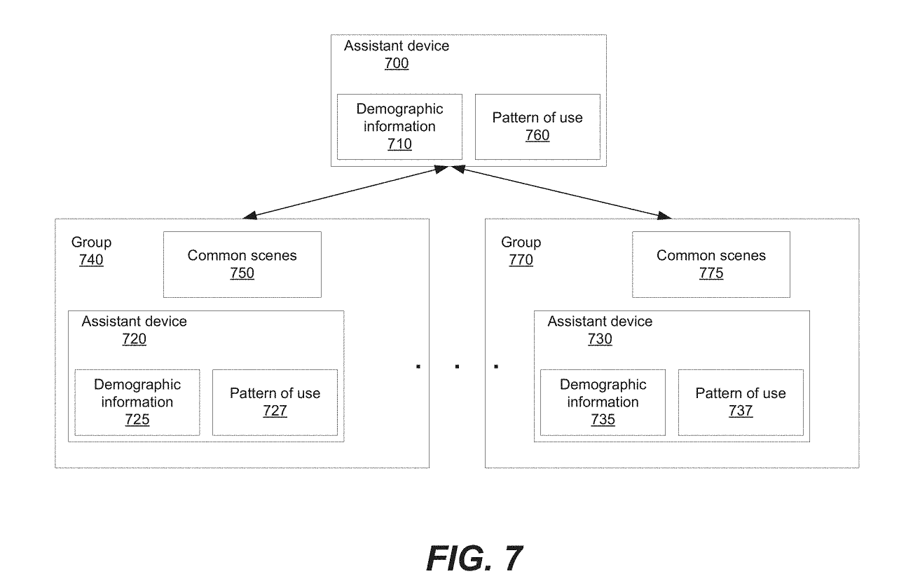

FIG. 7 shows the assistant device utilizing anonymized pattern of use data from other assistant devices. The assistant device 700 can learn based on the pattern of use of other users similar to the user, who are using assistant devices similar to the assistant device 700. The pattern of use data can include the scenes as described in this application, and/or actions and triggers gathered by the assistant device 700 that have not been grouped into scenes.

For example, when the assistant device 700 is initialized, and has not been used by the user, the assistant device 700 can gather demographic information 710 from the user, such as address, age, employment, etc. Based on the demographic information 710 from the user, and the demographic information 725, 735 collected from the other users of other assistant devices 720, 730, the assistant device 700 can determine that the user of the assistant device 700 is most similar to the group of users 740, including the assistant device 720. Consequently, the assistant device 700 can download the most common scenes 750 used by the group of users 740. The common scenes 750 can be generated from the user information 727 associated with the assistant device 720. The group 740 can include one or more users, and/or one or more assistant devices 720.

In another example, the assistant device 700, after being used by the user, can regroup the user based on the pattern of use 760 associated with the user and the demographic information 710, into a different group 770, including the assistant device 730. Based on the common scenes 775 contained in the group 770, the assistant device 700 can create new scenes, and new triggers for the scenes and actions, as described in this application. The common scenes 775 contained in the group 770 can be based on the pattern of use 737 associated with the assistant device 730. The group of users 770 can include one or more users, and/or one or more assistant devices 730. Groups of users 740 and 770 can be overlapping.

When receiving the common scenes 750, 775 from other assistant devices 720, 730, the assistant device 700 can blend, i.e. adjust, the common scenes 750, 775 to correspond to the home appliances available to the assistant device 700. For example, if a type of the dishwasher is different between the common scenes 750, 775 and the dishwasher controlled by the assistant device 700, then the assistant device 700 can modify the common scenes 750, 775 to work with the dishwasher controlled by the assistant device 700. In another example, if the common scenes 750, 775 contained a mixture of actions associated with two or more users, and the assistant device 700 is used by a single user, the assistant device 700 can do one of several things: in the common scenes 750, 775 keep actions of a single user most similar to the user of the assistant device 700 and remove the actions of the other users; assign the actions of all the users in the common scenes 750, 775 to a single user.

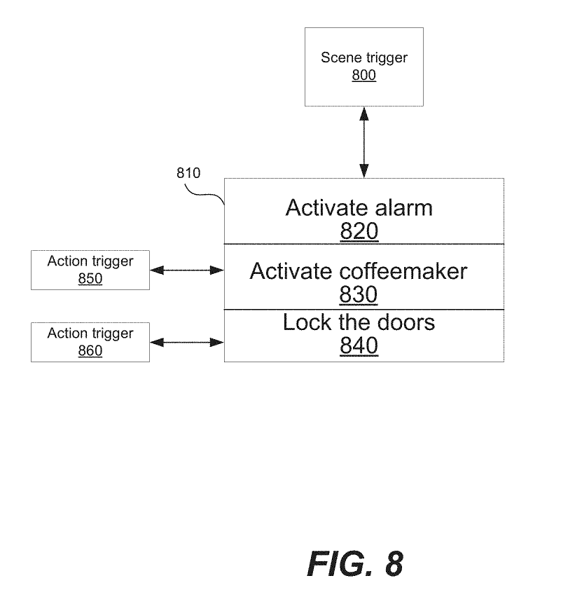

FIG. 8 shows various triggers for a scene and/or triggers for an action within the scene. The assistant device can recognize various scene triggers 800 associated with a particular scene 810 and can perform and/or offer to perform the scene 810. The morning scene 810 can include three actions: activate the alarm 820, activate the coffeemaker 830, and lock the doors 840. Further, the assistant device can recognize various action triggers 850, 860 and can perform and/or offer to perform an action 820, 830, 840.

The scene trigger 800 can be based on time. For example, the assistant device can learn what time the user wakes up in the morning, based on the day of the week, user's wake up habits, and/or based on the user's calendar, and activate the morning scene 810.

In another example, the scene trigger 800 can be based on the user's presence at home. The assistant device can track the presence of the user in the home and decide to activate or not activate the scene 810 based on the user's presence. The assistant device can determine the user's presence by tracking the user's mobile appliance, by detecting a user in a video inside the house, by detecting the user's voice inside the house, through biometric means such as a user fingerprint on an appliance inside the home associated with the assistant device, and/or a user's presence in bed. If the user is not at home, the assistant device can forgo activating the scene 810, even though the time to activate the alarm has come.

In a third example, the scene trigger 800 can be based on pattern matching. The assistant device can detect that the user has performed several actions that match an order of actions in a scene. Consequently, the assistant device can perform and/or offer to perform the remainder of the actions in the scene. To determine which scene the user wants to perform, the assistant device can unambiguously identify the scene because the order of the actions so far performed is solely associated with the scene. If the order of the actions matches several scenes, one of the scenes can be sufficiently more probable than the rest of the scenes, and consequently the assistant device can offer to perform the more probable scene. The more probable scene can be, for example, 50% more probable than the rest of the matching scenes.

Similarly, the action trigger 850, 860 can be based on time, user's location in the house, user's presence in the house, pattern matching etc. For example, the action 830, “activate coffeemaker”, can always be performed 15 minutes after the first action 820 in the scene 810 is performed. The 15 minutes can be specified by the user, or the assistant device can learn an average amount of time for the user to begin to consume coffee after the alarm has been activated.

In another example, the action trigger 850, 860 can be based on the user's location in the house. The assistant device can track the user's position in the home, for example using the location of a mobile appliance associated with the user, and set the trigger 850, 860 to be the moment the user exits the bedroom. In other words, when the user exits the bedroom, the action 820 is triggered.

In a third example, the action trigger 850, 860 can be based on the user's presence in the house. The assistant device can detect when the user has left the home, such as when the mobile appliance associated with the user is not present in the house, and trigger action 830, “lock the doors.”

In all the examples described in this application, the assistant device can ask the user for confirmation before performing a scene. As a result, the user can remain in control of the actions performed within the home. Similarly, if a scene is in progress, and the user decides to stop the scene, the user can stop the scene in progress using a voice command, through graphical user interface, by pressing a button, etc.

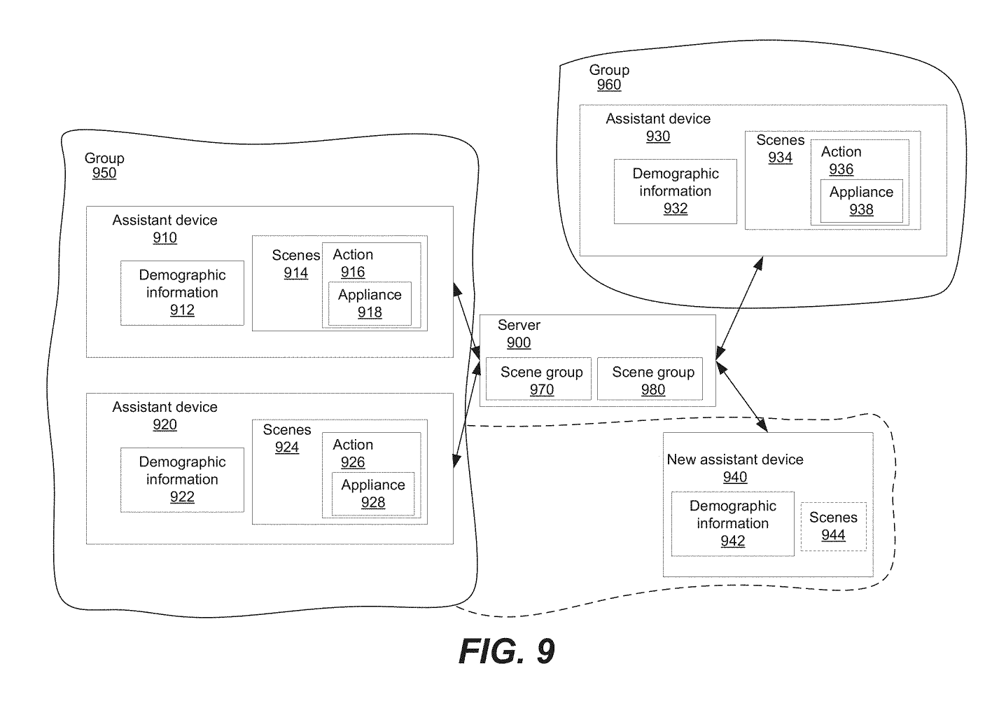

FIG. 9 shows a system to initialize a new assistant device. The system includes a server 900, multiple assistant devices 910, 920, 930, and the new assistant device 940. The server 900 can communicate with, and share information between, the assistant devices 910, 920, 930 and the assistant device 940. The shared information can be anonymized before being communicated to a different assistant device.

The assistant device 910, 920, 930 can contain demographic information 912, 922, 932 associated with the one or more users of the assistant device 910, 920, 930. A single assistant device 910, 920, 930 can store demographic information 912, 922, 932 per each user of the assistant device 910, 920, 930. Further, the assistant device 910, 920, 930 can store the scenes 914, 924, 934 utilized by the users of the respective appliances. The scenes 914, 924, 934 can be associated with a particular user. The scenes 914, 924, 934 can include the actions 916, 926, 936 which in turn can include the appliances 918, 928, 938.

When the assistant device 940 joins the local network, and/or at some point during the operation of the assistant device 940, such as a reset of the appliance 940, the assistant device 940 can be initialized using scenes of other similar assistant devices 910, 920, 930. The initialization can be performed by one or more processors of the server 900, or by one or more processors of the assistant device 940.

For example, the processor of the server 900 can be a central hub communicating with all the assistant devices 910, 920, 930, 940, or the assistant devices 910, 920, 930, 940 can be organized in a peer-to-peer network. When the network is peer-to-peer, the assistant device sending scene information to another assistant device can anonymize the scene information before sending.

The processor can obtain from the assistant devices 910, 920, 930 associated with multiple users demographic information 912, 922, 932 of the users and the scenes 914, 924, 934 including an action 916, 926, 936 and an appliance 918, 928, 938 associated with the action 916, 926, 936.

Based on the demographic information 912, 922, 932, the processor can group the users into multiple user groups 950, 960 and the scenes 914, 924, 934 into multiple scene groups 970, 980. The scene group 970 comes from the user group 950 and includes scenes 914, 924. The scene group 980 comes from the user group 960 includes scene 934.

The processor can group a user of the appliance 940 into the user group 950 by matching demographic information 942 of the user and the demographic information 912, 922 associated with the group 950 of users. The demographic information 912, 922, 932, 942 can include various parameters such as age of the user, gender of the user, employment of the user, user's working hours, distance between home and work, appliances available to the assistant device 910, 920, 930, 940, etc. The matching of the demographic information can be done by matching the various parameters within the demographic information.

For example, some parameters can be more important to match than others, or the parameters can be arranged in a hierarchical order from most important to the least important. In a more specific example, each parameter can have an assigned weight such as, appliances available to the assistant device can carry a weight of 10, user's working hours can have a weight of 8, while the remainder of the parameters can have a weight between 0 and 8. Alternatively, all the parameters can have equal weight. The highest matching score between demographic information of two or more users is the sum of all the parameter weights.

The demographic information between the two users can be compared parameter by parameter, where the degree of similarity can be expressed on a normalized scale, e.g. between 0 and 100. The parameter describing appliances available to the assistant device can have a 70% match between two users (i.e., the assistant devices share 70% of the appliances between each other). Similarly, other parameters can have other numeric matches between 0 and 100%. To calculate the match between 2 users, the processor can multiply the percentage match by the weight of the parameter (which can vary per parameter, or be the same for all the parameters) and divide the resulting number by the sum of all the parameter weights. The resulting number can vary between 0 and 1. Two users can be grouped in the same demographic group if the resulting number is above a predefined threshold, such as 0.5 or higher. Consequently, the processor can create user groups 950, 960, and the group the user of the assistant device 940 into the user group 950.

Once the user of the assistant device 940 is grouped, the processor can provide the one or more scenes from the scene group 970 associated with the user group 950 to the assistant device 940. The one or more scenes can be the most common scenes of the scene group 970, the scenes that include appliances best matched to the appliances available to the assistant device 940, scene selected by the user of the assistant device 940, all the scenes from the scene group 970, etc. If the one or more scenes provided to the assistant device 940 contain actions including appliances that are not available to the assistant device 940, the assistant device 940 can delete those actions from the one or more scenes.

The processor can receive one or more actions and one or more appliances coupled to the assistant device. The action can include an identification (ID) of the appliance and an instruction associated with the appliance. The appliance can be lights, camera, stove, oven, thermostat, speaker, television, yard and/or fire sprinklers, etc. The instruction can be to activate, turn off, set a program, activate to a certain degree, etc. The ID of the appliance can be a generic ID, or a specific ID, as described in the specification.

The processor can group the actions into a scene by determining a distinguishing characteristic associated with each action and creating the scene including one or more actions having the same distinguishing characteristic. The distinguishing characteristics can be the user requesting the action, the appliance performing the action, an area, such as a room, where the action is performed, the time at which the action is performed, user's habits, etc.

The processor can determine a scene trigger of the scene by identifying a condition that is frequently present before the scene is performed such as a particular time, user's presence or absence from an area associated with the assistant device such as a home, or based on pattern matching. To pattern match, the assistant device can determine that the user has performed one or more actions that correspond to the scene above a predetermined threshold, such as above 70%. Once the recently executed actions match a stored scene above the predetermined threshold, the assistant device can offer and/or can perform the matched scene.

The processor can recognize that the condition is present, and upon recognizing the condition is present, the processor can offer to perform the scene.

The processor can change the membership of groups 950, 960 based on learning user's habits, and/or forming new scenes etc. For example, after initializing the assistant device 940, the processor can change the grouping of the assistant device 940 based on the pattern of use of the assistant device 940. Pattern of use can include scenes formed by the assistant device 940, and/or commands and additional information gathered by the assistant device that have not been grouped into scenes. The additional information can include potential scene triggers and potential grouping of the actions. In a more specific example, the processor can obtain scenes 944 associated with the assistant device 940 and the scenes 914, 924, 934 associated with the assistant devices 910, 920, 930.

The processor can determine a group of similar scenes among the scenes 914, 924, 934, 944. Similar scenes can be found by matching actions and appliances within the scenes, above a predetermined threshold. For example, if appliances and actions performed by the appliances between 2 scenes match each other 70% of the time, then the 2 scenes are considered to be similar. The ID of the appliances in the ID of the actions can be generic when doing the matching.

Once the scenes 940, 924, 934, 944 have been grouped by similarity, the processor can determine which scene's in the group are missing from the assistant device 940. The processor can offer to and/or provide the missing scenes to the assistant device 940.

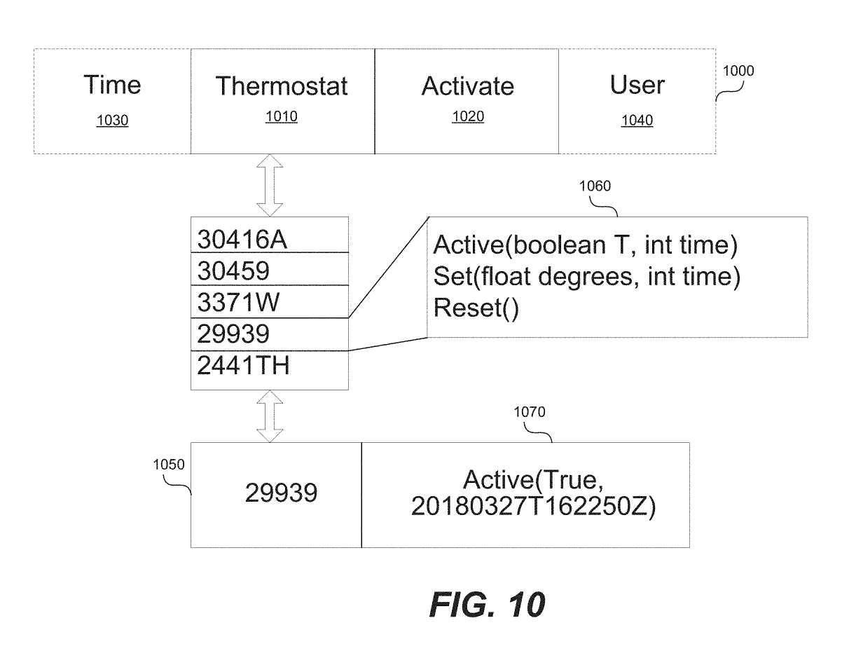

FIG. 10 shows a relationship between a generic ID of an appliance, and a generic appliance instruction and a specific ID of an appliance and the specific appliance instruction. An action 1000 associated with the scene stored on an assistant device can include generic ID 1010, a generic appliance instruction 1020, and optionally, a time 1030, and the user ID 1040. The user ID 1040 can identify the user that has performed the action 1000. The time 1030 can indicate the time at which the action 1000 was performed, or a time that you pass between performing the first action in the scene and performing the action 1000.

The generic ID 1010 of an appliance can indicate a function of the appliance, without identifying the maker of the appliance, the brand of the appliance, color of the appliance, a particular model the appliance, etc. For example the generic ID 1010 of the appliance can be “light”, “thermostat”, “lock”, “coffee maker”, etc.

The generic appliance instruction 1020 can indicate a particular function that the appliance can perform, and/or a particular parameter associated with a particular function. The particular function can be “activate”, “deactivate”, “stop”, “heat”, while a particular parameter can be “72°”, “at 8 a.m.”, etc.

The action 1000 can be a data structure stored on the assistant device, representing the action to be performed as part of a scene. The generic ID 1010, and a generic appliance instruction 1020, enables the sharing of actions and scenes among various assistant devices that may have various specific types of appliances associated with them. For example, the first assistant device can control a Venstar thermostat 30416A, while the second assistant device can control a Honeywell thermostat 29939. Instead of including specific ID, such as “30416A”, the action 1000 includes a generic ID 1010 stating “thermostat.” Consequently, the first assistant device can share the action 1000 with the second assistant device.

Once the second assistant device receives the action 1000, the second assistant device can obtain the specific ID 1050 of the appliance associated with a second assistant device. For example, the second appliance can obtain the ID “29939.” The specific ID 1050 can be stored in a memory of the second assistant device. Once the specific ID 1050 of the appliance has been obtained, the second assistant device can translate the generic appliance instruction 1020 into a specific appliance instruction 1070. The second assistant device can retrieve the set of all possible instructions 1060 associated with the appliance, and determine the best match with the generic appliance instruction 1020. In the present case the best match is the specific appliance instruction 1070.

Finally, the second assistant device can send a packet on the local network connecting the second assistant device and the appliance, where the payload of the packet contains the specific ID 1050 of the appliance and the specific appliance instruction 1070. The specific ID 1050 of the appliance can be the unique ID associated with that particular make and model the appliance, or can be a local network address of the appliance.

Further, a new appliance can be added to the assistant device. The assistant device can obtain the generic ID 1010 and the specific ID 1050 of the appliance from memory associated with the assistant device, or from a remote database associated with the server 900 in FIG. 9. The assistant device can request from the server 900 scenes belonging to the group of assistant devices 950 in FIG. 9 that contain the generic ID 1010. Upon receiving the requested scenes, the assistant device can determine whether the received scenes should be added wholesale, or rather only the action containing the generic ID 1010 should be added to already existing scenes. If the received scenes are already contained on the assistant device except for the additional action containing the generic ID 1010, the assistant device can add the action containing the generic ID 1010 to the already stored scenes. If the scenes are not already contained on the assistant device, the assistant device can add new scenes.

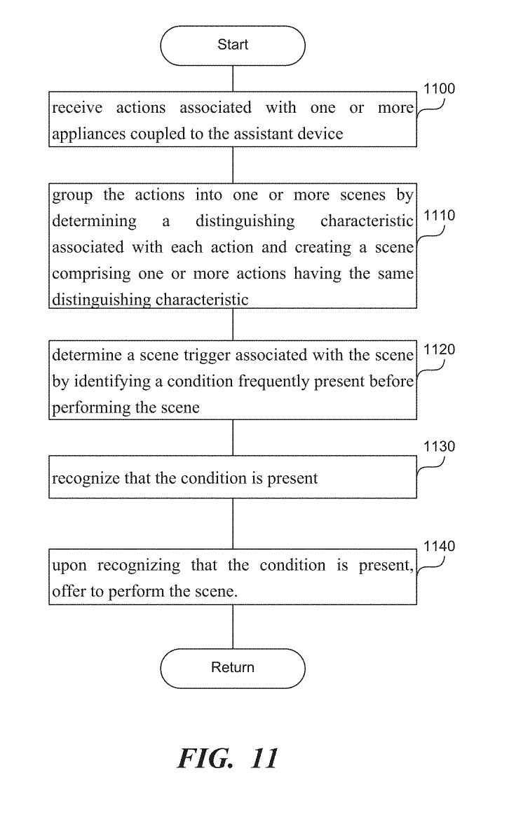

FIG. 11 is a flowchart of a method to automatically learn user's habitual actions of controlling home appliances and automatically offer to perform the user's habitual actions of controlling home appliances. The user does not have to put the assistant device in a special mode, or indicate to the assistant device that the assistant device should start learning. The assistant device can proactively offer to the user to learn the user's habits, or the assistant device can automatically learn the user's habits. The assistant device can also utilize artificial intelligence to group users, scenes, and actions, and create new scenes and actions based on the previously performed scenes and actions.

The assistant device can be associated with an area such as a home, office building, room, car, etc. The area can have subareas such as rooms and/or floors in the house, offices and/or floors in an office building, driver seat and back seats in a car, etc.

In step 1100, a processor associated with the assistant device can receive multiple actions associated with one or more appliances coupled to the assistant device. The action can include an identification (ID) of the appliance and an instruction associated with the appliance. The ID of the appliance can be a generic ID or a specific ID, while instruction can be a generic appliance instruction or a specific appliance instruction, as described in this application. The appliance can include lights, camera, stove, oven, thermostat, speaker, TV, etc.

In step 1110, the processor can group the actions into one or more scenes by determining a distinguishing characteristic associated with each action and can create a scene including one or more actions having the same distinguishing characteristic. The distinguishing characteristic can be an input from a user specifying an end to the scene, such as a voice input or an input through a user interface indicating to the assistant device to stop grouping subsequent actions with the previous actions.

The distinguishing characteristic can be a passage of time between 2 actions above a predetermined threshold. For example, if a previous and a subsequent action are separated by more than an hour, the 2 actions can be grouped into separate groups. The distinction characteristic can be the identity of the user, i.e. the person issuing the command. Identity of the user can be determined using voice identification, fingerprint identification of the user is interacting with the assistant device, visual identification, etc.

The distinguishing characteristic can be the appliance associated with the action. For example, actions controlling thermostats throughout the area associated with the assistant device can be grouped into one scene, while actions controlling lights throughout the area can be grouped into another scene.

The distinguishing characteristic can be a tendency of the user to perform a group of actions based on a pattern of use associated with the user, or a tendency of multiple users to perform a group of actions based on a of pattern of use associated with the users. The assistant device utilizing artificial intelligence can learn that the user, or a group of users tend to perform a specific group of actions together, and create a scene including the specific group of actions. For example, the assistant device can determine that before the alarm goes off in the morning, the water heater should be turned on, and after the alarm goes off in the morning, the coffee maker should be turned on.

Similarly, the assistant device can learn to exclude an action based on patterns of use. For example, the assistant device learns that the user tends to control lights and the television together, but in one instance, the user provides the commands to control a lock. The assistant device can offer to the user to group the lights and television actions into one scene, and the locks into another. Alternatively, the system can automatically create the 2 groups.

In step 1120, the assistant device can determine a scene trigger associated with the scene by identifying a condition frequently present before performing the scene. A frequently present condition can be a condition present 90% of the time before performing the scene. In step 1130, the assistant device can recognize the condition is present, and in step 1140 the assistant device can offer to perform the scene.

The scene trigger can be a command from the user to trigger the scene such as a voice command, or any command through a graphical user interface. The scene trigger can be the current time, such as when the current time corresponds to the average time when the scene is performed, or the current time has a specific relation to a time said by the user. For example, the current time can be some number of minutes before/after the morning alarm went off, the current time can be some number of minutes before/after an alarm went off, etc. The scene trigger can be a change in the user's presence within an area. For example, if the user leaves home in the morning, the assistant device can lock the home, or if the user leaves the room where the TV is, the assistant device can pause the TV or turn the TV off.

The scene trigger can be based on pattern matching. Specifically, the assistant device can receive one or more actions specified by the user, and determine that the actions are the initial actions in a stored scene. There can be only one stored scene, having the one or more actions as the initial actions, in which case the assistant device can offer to perform the only one stored scene. There can be multiple stored scenes having the one or more actions as the initial actions, in which case the assistant device can determine whether one of the scenes is significantly more frequently performed. For example, if one scene is twice as likely as the second most likely scene among multiple themes, the assistant device can offer to perform the one scene.

The assistant device can interface between the user and the one or more appliances, as described in FIG. 10, by translating an instruction received from the user into an action including a generic identification (ID) of an appliance and a generic appliance instruction. As described in the application, the generic ID and the generic appliance instruction can be shared among multiple assistant devices associated with various types of appliances having the same generic ID, but various specific IDs. The assistant device can store within the scene the generic ID and the generic appliance instruction. The generic ID and the generic appliance instruction are a higher-level representation, i.e. an abstraction, of the specific ID in the specific appliance instruction, thus enabling various types of appliances such as dishwashers, lights, coffeemakers, etc. to be controlled by the same action.

Based on the generic ID of the appliance, the assistant device can obtain a specific ID of the appliance. Based on the specific ID of the appliance and the generic appliance instruction, the assistant device can obtain a specific appliance instruction to send to the specific appliance. The assistant device can control the appliance by sending to the appliance the specific appliance instruction.

The assistant device can adjust a time when a scene is performed. The action in a scene can include a time, an ID of the appliance, an instruction associated with the appliance. The assistant device can adjust the time based on an initial time when an initial action in the scene is performed, or based on a user's presence within an area. The assistant device can perform the action at the adjusted time. The time can represent an offset, positive or negative from the initial time.

For example, the assistant device can activate the water heater 15 minutes before the morning alarm. User's presence can be determined based on tracking user's personal devices, based on locating the user through audio location, or based on locating the user through video recordings in the area associated with the assistant device.

New appliances can be connected to the assistant device, and the assistant device can provide the user with a set of relevant scenes including actions controlling the new appliance. After connecting the new appliance to the assistant device, the assistant device can obtain a generic identification (ID) of the new appliance, indicating a function associated with the new appliance. The assistant device can obtain, from a different assistant device associated with a different user and coupled to a different appliance having the generic ID, a scene including an action controlling the different appliance having the generic ID. The different assistant device can be part of a group of 950 in FIG. 9, in which the assistant device is grouped based on demographic information of the users, or based on pattern of use as described in FIG. 7. The obtained scene can be one of the most frequently performed scenes, such as in the top half of the most frequently performed scenes, having the action controlling the different appliances. The assistant device can store the obtained scene and offer to perform the scene to the user. The assistant device can also make a recommendation to the user to store the scene, and upon receiving approval from the user, store the scene.

The assistant device can determine that a user is outside of an area associated with the assistant device. The assistant device can make the determination by detecting that the user's personal appliance is not available within the local network used for communication between the assistant device and the personal appliance. The user's personal appliance can be a cell phone, a tablet, and/or an appliance implanted within the user. The assistant device can determine an action to perform while the user is outside of the area associated with the assistant device, such as locking the doors. The assistant device can send a notification to the user regarding the action, such as asking the permission to perform the action, or informing the user that the action has been performed.

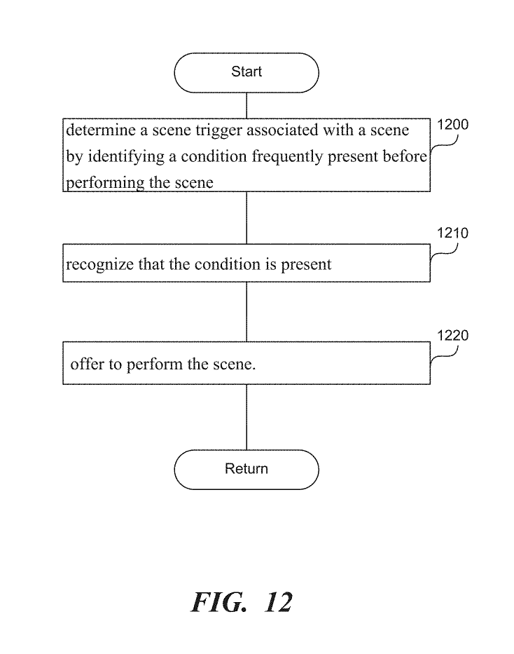

FIG. 12 is a flowchart of a method to determine a scene and/or action trigger. One or more processors (“processor”) associated with an assistant device are in communication with one or more appliances performing various functions such as locking the doors, blocking sunlight from coming through the windows, vacuuming a house, etc. The processor can store multiple scenes containing one or more actions that control the appliance. The processor can also store scene triggers and/or action triggers along with the scenes to indicate when the scene and/or action within the scene should be performed.

In step 1200, the processor can determine a scene trigger associated with a scene by identifying a condition frequently present before performing the scene. For example, the condition can be present 90% of the time when the scene is executed. The scene can include an action which includes a generic ID associated with the one or more appliances and generic appliance instruction associated with the one or more appliances. The generic ID, instead of specifying the make and model of the appliance, indicates the function associated with the appliance.

In step 1210, the processor, without a prompt from the user, can recognize that the condition is present. In step 1220, the processor, upon recognizing the condition is present, can offer to perform the scene.

The processor can receive multiple actions associated with one or more appliances coupled to the assistant device. An action can include the generic ID and/or a specific ID associated with the one or more appliances and the generic appliance instruction and/or a specific appliance instruction. The processor can group the received actions into one or more scenes by determining a distinguishing characteristic associated with each action and creating a scene including one or more actions having the same distinguishing characteristic. The distinguishing characteristics are described in this application.

The processor can determine the location of a user based on a personal appliance of the user, such as a cell phone, tablet, fitbit, smartwatch, smart glasses, or any other appliance in communication with the processor and carried by, or implanted within, the user. The processor can obtain an indication of an area associated with the assistant device. The area associated with the appliance can be a room, building, car, or open space with defined geographic coordinates. The indication of the area can include geographic coordinates such as global positioning system (GPS) coordinates, geographic coordinate system coordinates, very center coordinates, coordinates with respect to the assistant device, etc. The processor can determine whether the personal appliance is within the area associated with the assistant device, by, for example, trying to communicate with the personal appliance using the local network.

The processor can obtain a representation of an area associated with the assistant device, indicating multiple subareas within the area and an appliance associated with the subarea. For example, the representation can be a floorplan of the building, where subareas are rooms within the building. The processor can contain a table of the appliances that can affect the subarea, such as a room. For example, the processor can have a table of appliances which act within a subarea labeled “living room.” The table of appliances can include living room lights, living room television, fireplace, and thermostat.

The processor can group the actions into one or more scenes by the subarea. The processor can determine a subarea associated with the action in the scene. The processor can group the actions into one or more scenes by determining the distinguishing characteristic which, in this case, is the subarea in the plurality of subareas associated with the action. An action can affect more than one subarea within the area, such as turning on the thermostat on the upper floor of a house. The whole upper floor can be a subarea of the house.

The processor can determine the scene and/or action trigger associated with the scene and/or action by identifying a proximity of the user to a subarea within the area. For example in the morning, when the assistant device detects that the user has exited the bedroom, the system can trigger the coffee maker to make coffee.

The processor can obtain from multiple assistant devices associated with multiple users' demographic information and multiple scenes comprising an appliance instruction and an appliance. The processor can, based on the demographic information, group multiple users into multiple user groups and multiple scenes into multiple scene groups. The processor can group a first user into a user group among the multiple user groups based on demographic information associated with the first user and the demographic information associated with the group of users. To do the grouping, the processor can match age, employment, appliances available to the assistant device etc. the processor can provide a scene group associated with the user group to a first assistant device associated with the first user.

### Computer

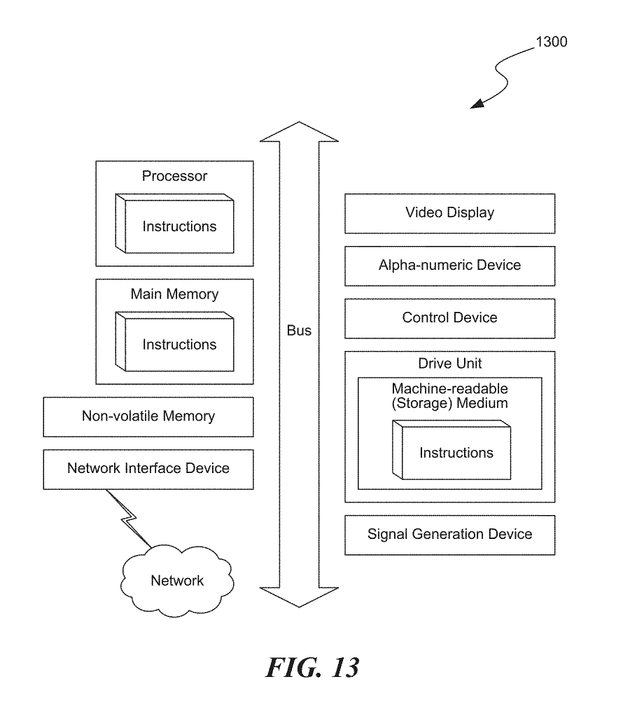

FIG. 13 is a diagrammatic representation of a machine in the example form of a computer system 1300 within which a set of instructions, for causing the machine to perform any one or more of the methodologies or modules discussed herein, may be executed.

In the example of FIG. 13, the computer system 1300 includes a processor, memory, non-volatile memory, and an interface appliance. Various common components (e.g., cache memory) are omitted for illustrative simplicity. The computer system 1300 is intended to illustrate a hardware appliance on which any of the components described in the example of FIGS. 1-12 (and any other components described in this application) can be implemented. The computer system 1300 can be of any applicable known or convenient type. The components of the computer system 1300 can be coupled together via a bus or through some other known or convenient appliance.

This disclosure contemplates the computer system 1300 taking any suitable physical form. As an example and not by way of limitation, computer system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1300 may include one or more computer systems 1300; be unitary or distributed; span multiple locations; span multiple machines; or reside in a cloud, which may include one or more cloud components in one or more networks. Where appropriate, one or more computer systems 1300 may perform without substantial spatial or temporal limitation one or more steps of one or more methods described or illustrated herein. As an example and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of appliance that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1300. The non-volatile storage can be local, remote, or distributed. The non-volatile memory is optional because systems can be created with all applicable data available in memory. A typical computer system will usually include at least a processor, memory, and an appliance (e.g., a bus) coupling the memory to the processor.

Software is typically stored in the non-volatile memory and/or the drive unit. Indeed, storing and entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface appliance. The interface can include one or more of a modem or network interface. It will be appreciated that a modem or network interface can be considered to be part of the computer system 1300. The interface can include an analog modem, ISDN modem, cable modem, token ring interface, satellite transmission interface (e.g. “direct PC”), or other interfaces for coupling a computer system to other computer systems. The interface can include one or more input and/or output appliances. The I/O appliances can include, by way of example but not limitation, a keyboard, a mouse or other pointing appliance, disk drives, printers, scanners, and other input and/or output appliances, including a display appliance. The display appliance can include, by way of example but not limitation, a cathode ray tube (CRT), liquid crystal display (LCD), or some other applicable known or convenient display appliance. For simplicity, it is assumed that controllers of any appliances not depicted in the example of FIG. 13 reside in the interface.

In operation, the computer system 1300 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “generating,” or the like, refer to the action and processes of a computer system, or similar electronic computing appliance, that manipulates and transforms data represented as physical (electronic) quantities within the computer system's registers and memories into other data similarly represented as physical quantities within the computer system memories or registers or other such information storage, transmissions, or display appliances.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone appliance or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, client computer, personal computer (PC), tablet PC, laptop computer, set-top box (STB), personal digital assistant (PDA), cellular telephone, iPhone, Blackberry, processor, telephone, web appliance, network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single, medium, or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module, or sequence of instructions referred to as “computer programs.” The computer programs typically comprise one or more instructions set at various times in various memory and storage appliances in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory appliances, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory appliances, such as a change in state from a binary one to a binary zero or vice-versa, for example, may comprise a transformation, such as a physical transformation. With particular types of memory appliances, such a physical transformation may comprise a physical transformation of an article to a different state or thing. For example, but without limitation, for some types of memory appliances, a change in state may involve an accumulation and storage of charge or a release of stored charge. Likewise, in other memory appliances, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory appliance may comprise a transformation, such as a physical transformation. Rather, the foregoing is intended as an illustrative example.

A storage medium typically may be non-transitory or comprise a non-transitory appliance. In this context, a non-transitory storage medium may include an appliance that is tangible, meaning that the appliance has a concrete physical form, although the appliance may change its physical state. Thus, for example, non-transitory refers to an appliance remaining tangible despite this change in state.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A method to automatically learn user's habitual actions of controlling home appliances and automatically offer to perform the user's habitual actions of controlling home appliances, the method comprising:
receiving, by an assistant device, a plurality of actions associated with one or more appliances coupled to the assistant device, an action in the plurality of actions comprising an identification (ID) of an appliance and an instruction associated with the appliance;
grouping, by the assistant device, the plurality of actions into one or more scenes by determining a distinguishing characteristic associated with each action in the plurality of actions and creating a scene comprising one or more actions having the same distinguishing characteristic;
determining, by the assistant device, a scene trigger associated with the scene by identifying a condition frequently present before performing the scene;
recognizing, by the assistant device, that the condition is present; and
upon recognizing that the condition is present, offering, by the assistant device, to perform the scene.

2. The method of claim 1, said determining the distinguishing characteristic comprising:
receiving an input from a user specifying an end to the scene;
determining a passage of time between two actions above a predetermined threshold;
determining an identity of the user;
determining the appliance associated with the action;
determining a tendency of the user to perform a group of actions based on a pattern of use associated with the user; or
determining a tendency of a plurality of users to perform the group of actions based on a plurality of patterns of use associated with the plurality of users.

3. The method of claim 1, said determining the scene trigger comprising:
receiving a command from a user to trigger the scene;
determining that a current time corresponds to a time when the scene is performed;
determining the current time has a predefined relation to a user-specified time; or
determining a change in a user's presence within an area.

4. The method of claim 1, said determining the scene trigger comprising:
receiving one or more actions specified by a user;
determining that the one or more actions correspond to the scene stored by the assistant device; and
offering to perform the rest of the scene.

5. The method of claim 1, comprising interfacing between a user and the one or more appliances, said interfacing comprising:
translating a command received from the user into the action associated with the scene, the action comprising a generic identification (ID) of the appliance and a generic appliance instruction wherein the generic ID and the generic appliance instruction can be shared among a plurality of assistant devices associated with various types of appliances having the same generic ID; and
storing the scene comprising the generic ID and the generic appliance instruction.

6. The method of claim 5, comprising:
based on the generic ID of the appliance obtaining a specific ID of the appliance associated with the assistant device;
based on the specific ID of the appliance and the generic appliance instruction, obtaining a specific appliance instruction to send to the appliance; and
sending to the appliance the specific appliance instruction.

7. The method of claim 1, wherein the action in the plurality of actions comprises a time associated with the action, the ID of the appliance, the instruction associated with the appliance; the method comprising:
adjusting the time associated with the action based on a time when an initial action in the scene was performed, or based on a user's presence within an area; and
performing the action at the adjusted time.

8. The method of claim 1, comprising:
connecting a new appliance to the assistant device by obtaining a generic identification (ID) of the new appliance, wherein the generic ID indicates a function associated with the new appliance;
obtaining, from a different assistant device associated with a different user and coupled to a different appliance having the generic ID, the scene comprising the different appliance having the generic ID; and
storing the scene comprising the different appliance having the generic ID on the new appliance.

9. The method of claim 1, comprising:
determining that a user is outside of an area associated with the assistant device;
determining the action to perform while the user is outside of the area associated with the assistant device; and
sending a notification to the user regarding the action.

10. A method comprising:
obtaining, from a plurality of assistant devices associated with a plurality of users, demographic information associated with the plurality of users and a plurality of scenes comprising an action and an appliance associated with the action;
based on the demographic information, grouping the plurality of users into a plurality of user groups and the plurality of scenes into a plurality of scene groups, wherein each scene group in the plurality of scene groups is associated with a user group in the plurality of user groups;
grouping a first user associated with a first assistant device into a first user group in the plurality of user groups based on demographic information associated with the first user and the demographic information associated with the user group; and
providing a first scene group associated with the first user group to the first assistant device associated with the first user.

11. The method of claim 10, comprising:
obtaining a generic identification (ID) associated with the appliance in communication with the first assistant device, wherein the generic ID indicates a function associated with the appliance;
determining that a scene in the scene group comprises the generic ID associated with the appliance; and
upon said determining, providing the scene to the first assistant device associated with the first user.

12. The method of claim 10, comprising:
receiving one or more actions associated with one or more appliances coupled to the first assistant device, the action in the one or more actions comprising an identification (ID) of the appliance and an instruction associated with the appliance;
grouping at least a portion of the one or more actions into a first scene by determining a distinguishing characteristic associated with each action and creating the first scene comprising the portion of the one or more actions having the same distinguishing characteristic;
determining a scene trigger associated with the first scene by identifying a condition frequently present before performing the first scene;
recognizing that the condition is present; and
upon recognizing the condition is present, offering to perform the first scene.

13. The method of claim 10, comprising:
obtaining a first plurality of scenes associated with the first assistant device and the plurality of scenes associated with the plurality of assistant devices;
determining a group of similar scenes among the plurality of scenes in the first plurality of scenes, wherein actions and appliances associated with the actions among 2 or more similar scenes match each other above a predetermined threshold; and
providing the group of similar scenes to the first assistant device associated with the first user.

14. A system comprising:
an appliance to perform a function;
one or more processors associated with an assistant device in communication with the appliance, the one or more processors executing instructions comprising:
instructions for determining, by the assistant device, a scene trigger associated with a scene by identifying a condition frequently present before performing the scene, wherein the scene comprises a generic ID associated with the appliance and a generic appliance instruction associated with the appliance, wherein the generic ID indicates the function associated with the appliance;
instructions for recognizing that the condition is present; and
instructions for, upon recognizing the condition is present, offering to perform the scene.

15. The system of claim 14, the instructions comprising:
instructions for receiving, by the assistant device, a plurality of actions associated with the appliance coupled to the assistant device, an action in the plurality of actions comprising the generic ID associated with the appliance and the generic appliance instruction associated with the appliance; and
instructions for grouping, by the assistant device, the plurality of actions into one or more scenes by determining a distinguishing characteristic associated with each action in the plurality of actions and creating the scene comprising one or more actions having the same distinguishing characteristic.

16. The system of claim 14, comprising:
a personal appliance associated with a user in communication with the one or more processors associated with the assistant device;
the one or more processors executing instructions comprising:
instructions for obtaining an indication of an area associated with the assistant device; and
instructions for determining whether the personal appliance is within the area associated with the assistant device.

17. The system of claim 14, the instructions comprising:
instructions for obtaining a representation of an area associated with the assistant device, the geometric representation indicating a plurality of subareas within the area and the appliance associated with a subarea in the plurality of subareas.

18. The system of claim 17, the instructions comprising:
instructions for determining the subarea in the plurality of subareas associated with an action in the scene; and
instructions for grouping a plurality of actions into one or more scenes by determining the distinguishing characteristic comprising the subarea in the plurality of subareas associated with the action.

19. The system of claim 17, the instructions comprising:
instructions for determining the scene trigger associated with the scene by identifying a proximity of a user to the subarea in the plurality of subareas.

20. The system of claim 14, the instructions comprising:
instructions for obtaining, from a plurality of assistant devices associated with a plurality of users, demographic information associated with the plurality of users and a plurality of scenes comprising an appliance instruction and the appliance;
instructions for based on the demographic information, grouping the plurality of users into a plurality of user groups and the plurality of scenes into a plurality of scene groups;
instructions for grouping a first user into a user group in the plurality of user groups based on demographic information associated with the first user and the demographic information associated with the user group; and
instructions for providing a scene group associated with the user group to a first assistant device associated with the first user.
